(19) United States
(12) Patent Application Publication
(10) Pub. No.: US 2022/0162899 A1
(43) Pub. Date: May 26, 2022

(54) ENERGY MANAGEMENT SYSTEM FOR A FURNITURE ITEM

(71) Applicant: BORTOLUZZI SISTEMI S.P.A., Belluno (IT)

(72) Inventors: Angelo IRRERA, Belluno (IT); Adriano GIROTTO, Belluno (IT)

(21) Appl. No.: 17/440,802

(22) PCT Filed: Mar. 26, 2020
(86) PCT No.: PCT/IB2020/052843

§ 371 Date: Sep. 20, 2021

(30) Foreign Application Priority Data
Mar. 27, 2019 (IT) 102019000004545

(51) Int. Cl. E05F 15/641; E05D 15/06

(52) U.S. Cl. CPC E05F 15/641; E05D 15/063; E05Y 2201/64; E05Y 2900/20; E05Y 2400/616; E05Y 2600/46; E05Y 2400/302

(57) ABSTRACT

To create a system for a furniture item that is electrically powered and functionally more flexible, with improved energy consumption, and independent from the mains voltage, an energy management method is proposed with the the steps of
(i) generating electrical energy from the displacement of a component (C; 30) of a furniture item movable by a user,
(ii) storing electrical energy thus generated in an electric accumulator (B), preferably placed onboard the furniture item.

The invention refers to an energy management system for a furniture item (e.g. for home decor).

In the world of furniture e.g. sliding systems for doors are known that are equipped with cushioning and return members, e.g. pneumatic or oil dampers and return springs. For standardization reasons, the sizing of these members is calculated on the basis of the weights and dimensions of doors commonly used in the market, which sizing does not ensure optimum operation in any conditions. Another disadvantage is that the dynamic response of the mechanical damping and return members is difficult to modulate a posteriori, and in each case is set in the design phase with little freedom of customization.

It is clear that instead it would be preferable to have more functionally flexible systems.

Several of the aforementioned systems are electrically powered from the mains and use an electric motor. The consumption of electrical energy is not negligible, and a true standardization is lacking e.g. on the mains supply voltage, different in various countries.

The main object of the invention is to improve this state of the art.

Another object is to provide a system for furniture items that are electrically powered and functionally more flexible, with improved and mains-voltage-independent energy consumption.

It is then proposed an energy management method with the steps of

(i) generating electrical energy from the displacement of a component of a furniture item movable by a user,

(ii) storing electrical energy thus generated in an electric accumulator, preferably placed onboard the furniture item.

In this way it is possible to generate electrical energy for and within the furniture item without depending on the presence or compatibility of the public power supply mains.

In a preferred variant of the method the electrical energy is obtained by converting kinetic energy of the component into electrical energy. When the component is in free motion it possesses kinetic energy that can be transformed into electrical energy, e.g. by an electric motor or dynamo used as generator.

In particular, kinetic energy of the component can be converted into energy also electric energy to simultaneously brake the movement of the component as it moves.

In a preferred variant of the method the electric energy is obtained by converting mechanical work applied to the component by the user to move it. When the component is moved manually a mechanical work of the user on the component can be exploited to generate electric energy, e.g. through an electric motor or dynamo used as generator.

In a preferred variant of the method the stored electrical energy is used to move the component, in particular for supplying a rotary electric motor or a linear actuator connected to the component. One gets thus the advantage of moving the component in a way energetically autonomous from the public power supply mains.

In a preferred variant of the method the stored electrical energy is exploited to brake the component, in particular for powering an electric brake connected to the component. Thus the advantage is obtained of braking or dampening the component via an electric (e.g. linear) actuator or a rotary electric motor, no longer by mechanical systems such as in the prior art. In addition, the dynamic behavior of the actuator or electric motor is more easily programmable, and certainly is not limited by structural constraints of the mechanical systems.

In a more preferred variant of the method, the dynamic behavior of the actuator or electric motor, powered by said stored energy, is programmed for conferring to the motion or trajectory of the component a predefined course. E.g. the stored electrical energy can be used to move or brake the component according to a programmed or programmable dynamic reference (e.g. speed and/or acceleration). In particular, the dynamic reference comprises speed and/or acceleration ramps, and/or activation timings.

In a preferred variant of the method, the start and/or end instant of the step (i) and/or (ii) is established as a function of the position of the component along its stroke. Or, the instant of start and/or end of the aforementioned step of electrical braking or actuation/displacement of the component is established as a function of the component's position along its stroke. Thus the dynamic behavior of the component can be programmed during its movement.

In a preferred variant of the method the stored electrical energy is exploited for supplying

a source of illumination of the component and/or of the furniture item, and/or

electrical components or electrical loads mounted onboard the furniture item.

Therefore, the advantages of power saving are extended to additional components.

Another aspect of the invention relates to a furniture item, comprising:

a component movable by a user,

means—or a generator—for generating electrical energy from the displacement of the component,

an electric accumulator arranged onboard the furniture item for storing electrical energy thus converted.

In a preferred variant, the furniture item comprises means—or an electronic converter—for converting the component's kinetic energy into said electrical energy.

In a preferred variant the furniture item comprises means—or an electronic converter—for converting mechanical work applied by the user to the component into said electrical energy.

In a preferred variant the furniture item comprises an electrical user, e.g. a rotary electric motor (e.g. a brushless motor) or an electric linear actuator, which is connected to the component and powered by the electrical accumulator in order to be able to move the component.

In a preferred variant, the furniture item comprises an electrical user such as an electric brake connected to the component and powered by the electric accumulator so as to be able to brake the component.

In a preferred variant the furniture item comprises a programmable processor for managing

the storage of electrical energy into the accumulator and/or

a flow of electrical energy from the accumulator to the electric user for controlling the electrical user's operation.

In a preferred variant, the processor is programmed to control the electrical user so as to impose a dynamic reference on/to the component (e.g. speed and/or acceleration). In particular, the dynamic reference comprises speed and/or acceleration ramps, and/or activation/deactivation timings for the electric user.

In a preferred variant, the furniture item comprises a wireless communication interface, for example wi-fi or Bluetooth, which is connected to the programmable processor, the programmable processor being programmed to receive from the interface data or setting commands for the displacement dynamics of the component.

In a preferred variant the furniture item comprises a position sensor for detecting the component's position along its stroke, the sensor being connected to the programmable processor, the programmable processor being programmed to receive a position data from the sensor and control the motion dynamics of the component as a function of the position data.

E.g. the position sensor is a relative encoder, e.g. arranged on the electric motor, or a part of the motor (e.g. a Hall effect sensor). Or the position sensor is implemented through the programming of the microprocessor, which by means of a sensor detects the current absorbed by one or more phases of the motor and from the acquired data calculates the position of the component along its stroke.

The component of the furniture item is not limited to particular cases, and may be e.g. a translatable and/or liftable leaf, an extractable drawer or a shelf.

The advantages of the invention will be even clearer from the following description of a preferred example of system, making reference to the attached drawing in which

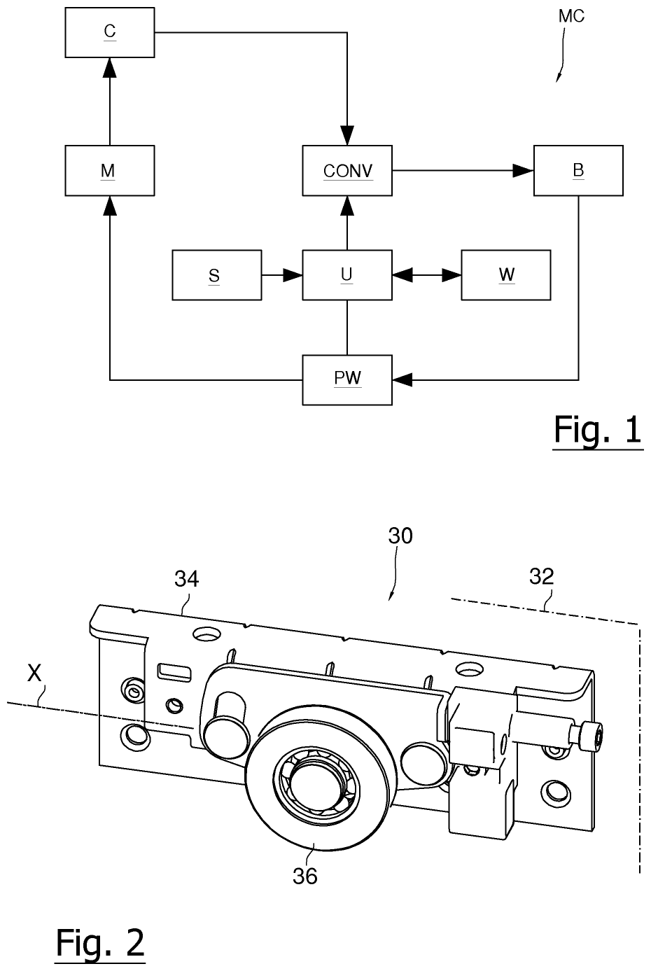

FIG. 1 shows a block diagram of an electronic system mounted in the furniture item;

FIG. 2 shows a three-dimensional view of a motorized sliding skid of a furniture item.

In the figures identical numbers indicate identical or conceptually similar parts, and elements are described as in use.

FIG. 1 shows in schematic form an energy management system MC installed in a furniture item (not shown) equipped with a generic displaceable component C, e.g. a leaf.

The displaceable component C is connected to an energy converter CONV and to electric driving member M. The energy converter CONV acts to convert a displacement of the component C into electrical energy, then stored in an electric accumulator B, and the driving member M acts to move the component C.

The arrows indicate energy or signal flow.

A microprocessor U controls the energy converter CONV, and is connected to an electronic power stage PW (e.g. an inverter) for controlling a flow of supply energy for the motor M withdrawn from the electric accumulator B.

Preferably, the microprocessor U is connected to a sensor S configured to detect the position of the component C along its stroke. So it is easier for the microprocessor U to determine whether and how to control the energy converter CONV for sending electrical energy to the accumulator B.

Therefore, the general operation of the system is as follows.

During a manual displacement of the component C, the microprocessor U intervenes to drive the energy converter CONV in order to generate electrical energy from such displacement and store it into the electric accumulator B.

Afterwards, the stored energy can be used e.g. to move the component C, and for this purpose the microprocessor U controls the electronic stage PW to power the driving member M.

Preferably the microprocessor U is connected to a wireless communication stage W, via which to receive from the outside setup data for the system, e.g. timing or dynamic profiles for the component C.

FIG. 2 shows an application of the system MC.

A skid for a furniture door 32 is indicated by 30.

The skid 30, corresponding to the component C of FIG. 1, is able to slide on a rail to move horizontally the leaf 32 back and forth (along the X axis) with respect to a compartment of the furniture item.

The skid 30 comprises a bracket 34 on which a wheel 36 is rotatably pivoted. The wheel 36 is part of the rotor of an electric, e.g. brushless, motor connected to an electric battery.

The skid 30 also comprises an electronic unit for managing the energy flow from the electric motor to the electric battery and vice versa.

When a person pushes the leaf 32, the wheel 36 rotates on the guide and generates electrical energy, which the electronic unit acts to accumulate into the electric battery.

In a subsequent phase, the electronic unit operates to supply with the electric battery the motor contained in the skid 30, and the wheel 36 now becomes a thruster for the sliding of the leaf 32.

The energy converter CONV and the electric driving member M may also coincide, as in the case of an electric motor exploitable as an actuator or an electric power generator.

1. Energy management method with the steps of
(i) generating electrical energy from the displacement of a component of a furniture item movable by a user,
(ii) storing electrical energy thus generated in an electric accumulator (B), preferably placed onboard the furniture item.

2. Method according to claim 1, wherein the electrical energy is obtained by converting kinetic energy of the component into electrical energy.

3. Method according to claim 1, wherein kinetic energy of the component is converted into electrical energy to simultaneously brake the movement of the component as it moves.

4. Method according to claim 1, wherein the electrical energy is obtained by converting mechanical work applied by the user to the component to move it.

5. Method according to claim 1, wherein the stored electrical energy is used to move the component, in particular to supply a rotary electric motor or an electric linear actuator connected to the component.

6. Method according to claim 1, wherein the dynamic behavior of an electric actuator or motor, power-supplied with said stored energy, is programmed to give the motion or trajectory of the component a predefined course.

7. Item of furniture comprising:
a component movable by a user,
means—or a generator—for generating electrical energy from the displacement of the component,
an electric accumulator placed onboard the furniture item for storing the converted electrical energy.

8. Item of furniture according to claim 7, comprising means—or an electronic converter—(CONV) for converting the kinetic energy of the component into said electric energy.

9. Item of furniture according to claim 7, comprising means—or an electronic converter—for converting mechanical work applied by the user to the component into said electrical energy.

10. Item of furniture according to claim 7, comprising an electrical user, e.g. a rotary electric motor or an electric linear actuator, which is connected to the component and powered by the electric accumulator so as to be able to move or brake the component.
